(19) United States
(12) Patent Application Publication
(10) Pub. No.: US 2025/0353775 A1
(43) Pub. Date: Nov. 20, 2025

(54) METHODS AND APPARATUS FOR MANUFACTURING A GLASS RIBBON

(71) Applicant: CORNING INCORPORATED, CORNING, NY (US)

(72) Inventors: Olus Naili Boratav, Ithaca, NY (US); Gary Graham Squier, Beaver Dams, NY (US); Andrey Yuryevich Ushakov, Espoo (FI)

(21) Appl. No.: 18/871,579

(22) PCT Filed: Jun. 23, 2023
(86) PCT No.: PCT/US2023/026061

§ 371 Date: Dec. 4, 2024

Related U.S. Application Data
(60) Provisional application No. 63/367,931, filed on Jul. 8, 2022.

(51) Int. Cl. C03B 17/06

(52) U.S. Cl. CPC C03B 17/064

(57) ABSTRACT

A glass manufacturing apparatus includes a forming device including a trough extending along a trough axis between an inlet end and an opposing end of the forming device. The forming device includes a pair of weirs. The forming device includes a diverter positioned within the trough for diverting a molten material over at least one weir of the pair of weirs. The diverter includes a first edge contacting a bottom surface of the trough. The first edge includes an upstream diverter edge segment and a downstream diverter edge segment nonlinear with the upstream diverter edge segment. The downstream diverter edge segment is positioned downstream from the upstream diverter edge segment. Methods of manufacturing glass are provided.

### CROSS REFERENCE TO RELATED APPLICATION

This application claims the benefit of priority under 35 U.S.C. § 119 of U.S. Provisional Application Ser. No. 63/367,931 filed on Jul. 8, 2022 the content of which is relied upon and incorporated herein by reference in its entirety.

### FIELD

The present disclosure relates generally to methods for manufacturing a glass ribbon and, more particularly, to methods for manufacturing a glass ribbon with a forming device comprising a diverter.

### BACKGROUND

It is known to manufacture a glass ribbon with a forming device. Conventional forming devices are known to operate to down draw a quantity of molten material from the forming device as the glass ribbon. However, a flow rate of the molten material exiting the forming device can be difficult to control. A shape of the forming device can be contoured to achieve desired flow rates. However, changing a shape of the forming device is inefficient and costly.

### SUMMARY

The following presents a simplified summary of the disclosure to provide a basic understanding of some aspects described in the detailed description.

There are set forth methods of manufacturing glass with a forming device. The forming device comprises a trough within which a molten material is received. The trough is bounded by a pair of weirs and a bottom surface. The forming device can comprise a diverter that is positioned on the bottom surface. The forming device comprises a diverter that can affect a flow rate of the molten material out of trough. As such, based on a shape of the diverter, the flow rate of the molten material exiting the trough can be increased or decreased.

In aspects, a glass manufacturing apparatus can comprise a forming device comprising a trough extending along a trough axis between an inlet end and an opposing end of the forming device opposite the inlet end. The forming device can comprise a pair of weirs. The forming dev [symbol] the trough for diverting a molten material over at least one weir of the pair of weirs. The diverter can comprise a first edge contacting a bottom surface of the trough. The first edge can comprise an upstream diverter edge segment and a downstream diverter edge segment nonlinear with the upstream diverter edge segment, and the downstream diverter edge segment is positioned downstream from the upstream diverter edge segment relative to a flow direction of the molten material in the trough.

In aspects, the bottom surface can be substantially planar and extends at least partially between the inlet end and the opposing end.

In aspects, the diverter can further comprise a second edge contacting the bottom surface. The second edge can comprise a second upstream diverter edge segment and a second downstream diverter edge segment nonlinear with the second upstream diverter edge segment, and the second downstream diverter edge segment positioned downstream from the second upstream diverter edge segment.

In aspects, the diverter can extend along a diverter axis between a first diverter end and a second diverter end. The first edge and the second edge can intersect at the first diverter end and diverge toward the second diverter end.

In aspects, a distance separating the first edge from the second edge can increase at a non-constant rate along the diverter axis from the first diverter end toward the second diverter end.

In aspects, a second distance separating the upstream diverter edge segment and the second upstream diverter edge segment can increase at a first rate along the diverter axis toward the second diverter end, and a third distance separating the downstream diverter edge segment and the second downstream diverter edge segment can increase at a second rate along the diverter axis toward the second diverter end.

In aspects, the first rate can be greater than the second rate.

In aspects, the first rate can be less than the second rate.

In aspects, a height of the diverter from the bottom surface at a center of the diverter can increase at a non-constant rate along the diverter axis from the first diverter end toward the second diverter end.

In aspects, the diverter can be homogeneous with the forming device.

In aspects, the forming device can be formed of a ceramic material and the diverter can comprise platinum.

In aspects, a glass manuf [symbol] device comprising a trough extending along a trough axis between an inlet end and an opposing end of the forming device opposite the inlet end. The forming device can comprise a bottom surface at least partially defining the trough and a pair of weirs extending from the bottom surface. The forming device can comprise a diverter positioned within the trough and configured to divert a molten material over at least one weir of the pair of weirs. The diverter can extend along a diverter axis between a first diverter end and a second diverter end. A height of the diverter from the bottom surface at a center of the diverter can increase at a non-constant rate along the diverter axis from the first diverter end toward the second diverter end.

In aspects, the diverter can further comprise a first face contacting the bottom surface and lying in a first plane. The diverter can comprise a second face contacting the bottom surface and lying in a second plane. The second face can be attached to the first face. The diverter can comprise a third face contacting the bottom surface and lying in a third plane non-planar with the first plane. The third face can be attached to the first face. The diverter can comprise a fourth face contacting the bottom surface and lying in a fourth plane non-planar with the second plane. The fourth face can be attached to the second face and the third face.

In aspects, the first face and the third face can lie on a first side of the diverter, and the second face and the fourth face can lie on a second side of the diverter opposing the first side.

In aspects, the first face can form a first angle relative to the bottom surface, and the third face can form a third angle relative to the bottom surface. The first angle can be different than the third angle.

In aspects, the second face can form a second angle relative to the bottom surface, and the fourth face can form a fourth angle relative to the bottom surface. The second angle can be different than the fourth angle.

In aspects, methods of manufacturing glass can comprise directing a molten material along a flow direction within a trough of a forming device. The trough can comprise a bottom surface and a pair of weirs extending from the bottom surface. Methods can comprise flowing the molten material over the pair of weirs. Methods can comprise diverting the molten material at a first flow rate over the pair of weirs at a first location of the trough when the molten material flows over a first portion of a diverter attached to the bottom surface. Methods [symbol] a second flow rate, different than the first flow rate, over the pair of weirs at a second location of the trough when the molten material flows over a second portion of the diverter. The second location can be positioned downstream from the first location relative to the flow direction.

In aspects, methods can comprise diverting the molten material at an upstream flow rate over the pair of weirs at a location of the trough upstream from the first location relative to the flow direction.

In aspects, the first flow rate can be less than the upstream flow rate and the second flow rate can be greater than the upstream flow rate.

In aspects, the first flow rate can be greater than the upstream flow rate and the second flow rate can be less than the upstream flow rate.

Additional features and advantages of the aspects disclosed herein will be set forth in the detailed description that follows, and in part will be clear to those skilled in the art from that description or recognized by practicing the aspects described herein, including the detailed description which follows, the claims, as well as the appended drawings. It is to be understood that both the foregoing general description and the following detailed description present aspects intended to provide an overview or framework for understanding the nature and character of the aspects disclosed herein. The accompanying drawings are included to provide further understanding and are incorporated into and constitute a part of this specification. The drawings illustrate various aspects of the disclosure, and together with the description explain the principles and operations thereof.

### BRIEF DESCRIPTION OF THE DRAWINGS

These and other features, aspects and advantages are better understood when the following detailed description is read with reference to the accompanying drawings, in which:

FIG. 1 schematically illustrates example aspects of a glass manufacturing apparatus in accordance with aspects of the disclosure;

FIG. 2 illustrates a perspective cross-sectional view of the glass manufacturing apparatus along lines 2-2 of FIG. 1 in accordance with aspects of the disclosure;

FIG. 3 illustrates a side vie [symbol] 2 in accordance with aspects of the disclosure;

FIG. 4 illustrates a perspective view of a diverter in accordance with aspects of the disclosure;

FIG. 5 illustrates a top-down view of the diverter in accordance with aspects of the disclosure;

FIG. 6 illustrates a side view of the diverter in accordance with aspects of the disclosure;

FIG. 7 illustrates a cross-sectional view of the diverter along lines 7-7 of FIG. 5 in accordance with aspects of the disclosure;

FIG. 8 illustrates a cross-sectional view of the diverter along lines 8-8 of FIG. 5 in accordance with aspects of the disclosure;

FIG. 9 illustrates a cross-sectional view of the diverter along lines 9-9 of FIG. 4 in accordance with aspects of the disclosure;

FIG. 10 illustrates a cross-sectional view of the diverter along lines 10-10 of FIG. 4 in accordance with aspects of the disclosure;

FIG. 11 illustrates a perspective view of a diverter in accordance with aspects of the disclosure;

FIG. 12 illustrates a top-down view of the diverter in accordance with aspects of the disclosure;

FIG. 13 illustrates a side view of the diverter in accordance with aspects of the disclosure; and

FIG. 14 illustrates a plot of a change in mass exiting a trough in accordance with aspects of the disclosure.

### DETAILED DESCRIPTION

Aspects will now be described more fully hereinafter with reference to the accompanying drawings in which example aspects are shown. Whenever possible, the same reference numerals are used throughout the drawings to refer to the same or like parts. However, this disclosure may be embodied in many different forms and should not be construed as limited to the aspects set forth herein.

As used herein, the term “about” means that amounts, sizes, formulations, parameters, and other quantities and characteristics are not, and need not be, exact, but may be approximate and [symbol] tolerances, conversion factors, rounding off, measurement error and the like, and other factors known to those of skill in the art.

Ranges can be expressed herein as from “about” one value, and/or to “about” another value. When such a range is expressed, aspects include from the one value to the other value. Similarly, when values are expressed as approximations by use of the antecedent “about,” it will be understood that the value forms another aspect. It will be further understood that the endpoints of each of the ranges are significant both in relation to the other endpoint, and independently of the other endpoint.

Directional terms as used herein—for example up, down, right, left, front, back, top, bottom, upper, lower, etc.—are made only with reference to the figures as drawn and are not intended to imply absolute orientation.

Unless otherwise expressly stated, it is in no way intended that any methods set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred in any respect. This holds for any possible non-express basis for interpretation, including matters of logic relative to arrangement of steps, operational flow, order of components, or orientation of components; plain meaning derived from grammatical organization or punctuation, and; the number or type of aspects described in the specification.

As used herein, the singular forms “a,” “an” and “the” include plural references unless the context clearly dictates otherwise. Thus, for example, reference to “a” component includes aspects having two or more such components, unless the context clearly indicates otherwise.

The word “exemplary,” “example,” or various forms thereof are used herein to mean serving as an example, instance, or illustration. Any aspect or design described herein as “exemplary” or as an “example” should not be construed as preferred or advantageous over other aspects or designs. Furthermore, examples are provided solely for purposes of clarity an [symbol] restrict the disclosed subject matter or relevant portions of this disclosure in any manner. It can be appreciated that a myriad of additional or alternate examples of varying scope could have been presented but have been omitted for purposes of brevity.

As used herein, the terms “comprising” and “including”, and variations thereof, shall be construed as synonymous and open-ended, unless otherwise indicated. A list of elements following the transitional phrases comprising or including is a non-exclusive list, such that elements in addition to those specifically recited in the list may also be present.

The terms “substantial,” “substantially,” and variations thereof as used herein are intended to represent that a described feature is equal or approximately equal to a value or description. For example, a “substantially planar” surface is intended to denote a surface that is planar or approximately planar. Moreover, “substantially” is intended to denote that two values are equal or approximately equal. The term “substantially” may denote values within about 10% of each other, for example, within about 5% of each other, or within about 2% of each other.

Modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first end and a second end generally correspond to end A and end B or two different ends.

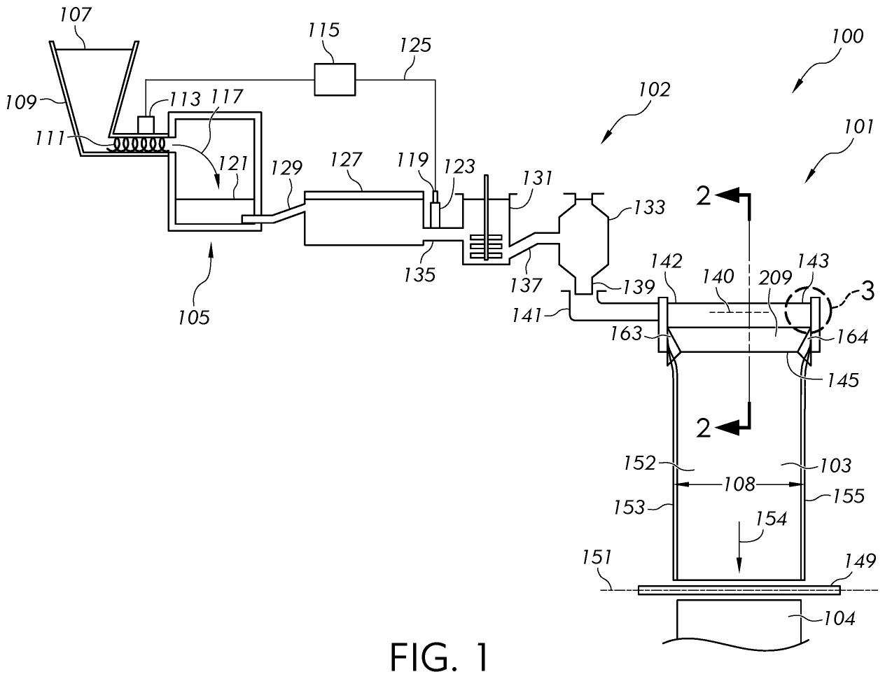

The present disclosure relates to a glass manufacturing apparatus and methods for producing a glass ribbon. Methods and apparatus for producing a glass ribbon from a glass material will now be described by way of example aspects. As schematically illustrated in FIG. 1, in aspects, an exemplary glass manufacturing apparatus 100 can comprise a glass melting and delivery apparatus 102 and a forming device 101 designed to produce a glass ribbon 103 from a quantity of molten material 121. The glass ribbon 103 can comprise a central portion 152 positioned between opposite edge portions (e.g., edge beads) formed along a first outer edge 153 and a second outer edge 155 of the glass ribbon 103, wherein a thickness of the edge portions can be greater than a thickness of the central portion. Additionally, in aspects, a separated glass ribbon 104 can be separated from the glass ribbon 103 along a separation path 151 by a glass separator [symbol] laser, etc.).

In aspects, the glass melting and delivery apparatus 102 can comprise a melting vessel 105 oriented to receive batch material 107 from a storage bin 109. The batch material 107 can be introduced by a batch delivery device 111 powered by a motor 113. In aspects, an optional controller 115 can be operated to activate the motor 113 to introduce a desired amount of batch material 107 into the melting vessel 105, as indicated by arrow 117. The melting vessel 105 can heat the batch material 107 to provide molten material 121. In aspects, a melt probe 119 can be employed to measure a level of molten material 121 within a standpipe 123 and communicate the measured information to the controller 115 by way of a communication line 125.

Additionally, in aspects, the glass melting and delivery apparatus 102 can comprise a first conditioning station comprising a fining vessel 127 located downstream from the melting vessel 105 and coupled to the melting vessel 105 by way of a first connecting conduit 129. In aspects, molten material 121 can be gravity fed from the melting vessel 105 to the fining vessel 127 by way of the first connecting conduit 129. For example, in aspects, gravity can drive the molten material 121 through an interior pathway of the first connecting conduit 129 from the melting vessel 105 to the fining vessel 127. Additionally, in aspects, bubbles can be removed from the molten material 121 within the fining vessel 127 by various techniques.

In aspects, the glass melting and delivery apparatus 102 can further comprise a second conditioning station comprising a mixing chamber 131 that can be located downstream from the fining vessel 127. The mixing chamber 131 can be employed to provide a homogenous composition of molten material 121, thereby reducing or eliminating inhomogeneity that may otherwise exist within the molten material 121 exiting the fining vessel 127. As shown, the fining vessel 127 can be coupled to the mixing chamber 131 by way of a second connecting conduit 135. In aspects, molten material 121 can be gravity fed from the fining vessel 127 to the mixing chamber 131 by way of the second connecting conduit 135. For example, in aspects, gravity can drive the molten material 121 through an interior pathway of the second connecting conduit 135 from the fining vessel 127 to the mixing chamber 131.

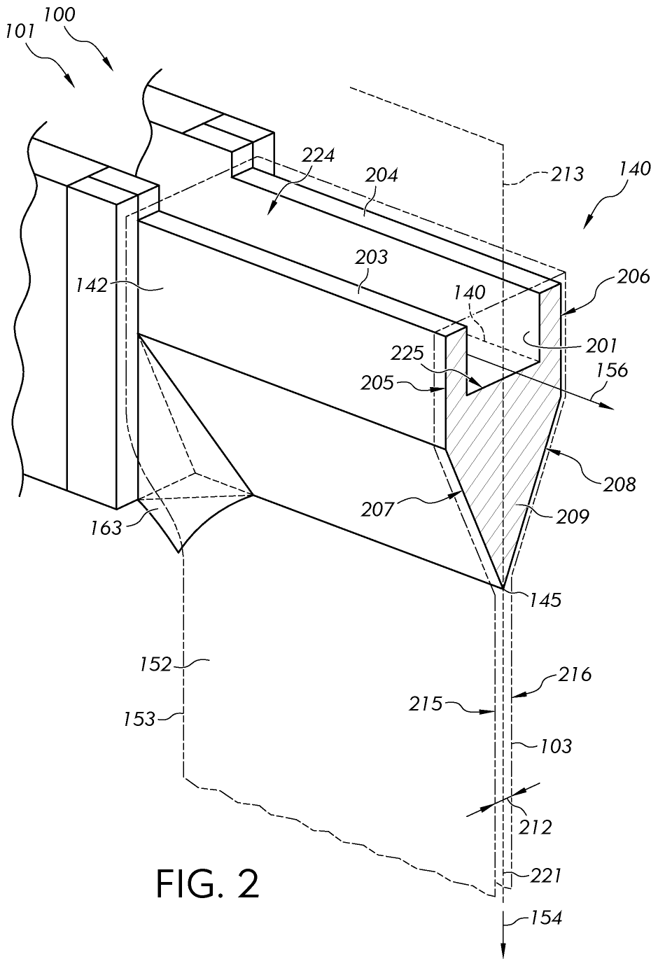

Additionally, in aspects, the glass melting and delivery apparatus 102 can comprise a third conditioning station comprising a delivery chamber 133 that can be located downstream from the mixing ch [symbol] 133 can condition the molten material 121 to be fed into an inlet conduit 141. For example, the delivery chamber 133 can function as an accumulator and/or flow controller to adjust and provide a consistent flow of molten material 121 to the inlet conduit 141. As shown, the mixing chamber 131 can be coupled to the delivery chamber 133 by way of a third connecting conduit 137. In aspects, molten material 121 can be gravity fed from the mixing chamber 131 to the delivery chamber 133 by way of the third connecting conduit 137. For example, in aspects, gravity can drive the molten material 121 through an interior pathway of the third connecting conduit 137 from the mixing chamber 131 to the delivery chamber 133. As further illustrated, in aspects, a delivery pipe 139 can be positioned to deliver molten material 121 to forming device 101, for example the inlet conduit 141 of the forming device 101. The forming device 101 can comprise a trough (e.g., trough 201 illustrated in FIG. 2) extending along a trough axis 140 between an inlet end 142 and an opposing end 143 of the forming device 101 opposite the inlet end 142. The inlet end 142 is the end of the trough 201 in proximity to the inlet conduit 141 through which the molten material 121 is received. The opposing end 143 is the end farthest from the inlet conduit 141.

By way of illustration, the forming device 101 shown and disclosed below can be provided to fusion draw molten material 121 off a bottom edge, defined as a root 145, of a forming wedge 209 to produce the glass ribbon 103. For example, in aspects, the molten material 121 can be delivered from the inlet conduit 141 to the forming device 101. The molten material 121 can then be formed into the glass ribbon 103 based, in part, on the structure of the forming device 101. For example, as shown, the molten material 121 can be drawn off the bottom edge (e.g., root 145) of the forming device 101 along a draw path extending in a travel direction 154 of the glass manufacturing apparatus 100. In aspects, edge directors 163, 164 can direct the molten material 121 off the forming device 101 and define, in part, a width 108 of the glass ribbon 103. In aspects, the width 108 of the glass ribbon 103 extends between the first outer edge 153 of the glass ribbon 103 and the second outer edge 155 of the glass ribbon 103.

In aspects, the width 108 of the glass ribbon 103, which extends between the first outer edge 153 of the glass ribbon 103 and the second outer edge 155 of the glass ribbon 103, can be greater than or equal to about 20 millimeters (mm), for example, greater than or equal to about 5 [symbol] about 100 mm, for example, greater than or equal to about 500 mm, for example, greater than or equal to about 1000 mm, for example, greater than or equal to about 2000 mm, for example, greater than or equal to about 3000 mm, for example, greater than or equal to about 4000 mm, although other widths less than or greater than the widths mentioned above can be provided in aspects. For example, in aspects, the width 108 can be within a range from about 20 mm to about 4000 mm, for example, within a range from about 50 mm to about 4000 mm, for example, within a range from about 100 mm to about 4000 mm, for example, within a range from about 500 mm to about 4000 mm, for example, within a range from about 1000 mm to about 4000 mm, for example, within a range from about 2000 mm to about 4000 mm, for example, within a range from about 3000 mm to about 4000 mm, for example, within a range from about 20 mm to about 3000 mm, for example, within a range from about 50 mm to about 3000 mm, for example, within a range from about 100 mm to about 3000 mm, for example, within a range from about 500 mm to about 3000 mm, for example, within a range from about 1000 mm to about 3000 mm, for example, within a range from about 2000 mm to about 3000 mm, for example, within a range from about 2000 mm to about 2500 mm, and all ranges and subranges therebetween.

FIG. 2 shows a cross-sectional perspective view of the forming device 101 along line 2-2 of FIG. 1. In aspects, the forming device 101 can comprise a trough 201 oriented to receive the molten material 121 from the inlet conduit 141. For illustrative purposes, cross-hatching of the molten material 121 is removed from FIG. 2 for clarity. The forming device 101 comprises a pair of weirs 203, 204 defining an opening 224 in the trough 201. The forming device 101 comprises a bottom surface 225, which may be substantially planar, and may extend at least partially between the inlet end 142 and the opposing end 143 (e.g., illustrated in FIG. 1). The bottom surface 225 can at least partially define the trough 201, for example, with the bottom surface 225 extending along a bottom of the trough 201 and the pair of weirs 203, 204 extending along opposing sides of the trough 201. In aspects, the bottom surface 225 can be substantially planar and may form a right angle with the pair of weirs 203, 204. In aspects, the bottom surface 225 can be substantially planar. The bottom surface 225 can comprise opposing edges that extend along the trough axis 140, with the opposing edges contacting the pair of weirs 203, 204. In aspects, the opposing edges can form a rounded shape with the pair of weirs 203 [symbol] bottom surface 225 and the pair of weirs 203, 204 (e.g., at the opposing edges) comprises a radius of curvature. The forming device 101 can further comprise the forming wedge 209 comprising a pair of downwardly inclined converging surface portions 207, 208 extending between opposed ends of the forming wedge 209. The pair of downwardly inclined converging surface portions 207, 208 of the forming wedge 209 can converge along the travel direction 154 to intersect along the root 145 (e.g., a bottom edge of the forming wedge 209 where the converging surface portions 207, 208 meet) of the forming device 101. A draw plane 213 of the glass manufacturing apparatus 100 can extend through the root 145 along the travel direction 154. In aspects, the glass ribbon 103 can be drawn in the travel direction 154 along the draw plane 213. As shown, the draw plane 213 can bisect the forming wedge 209 through the root 145 although, in aspects, the draw plane 213 can extend at other orientations relative to the root 145. In aspects, the glass ribbon 103 can move along a travel path 221 that may be co-planar with the draw plane 213 in the travel direction 154.

Additionally, the molten material 121 can flow in a flow direction 156 into and along the trough 201 of the forming device 101. The molten material 121 can then overflow from the trough 201 by flowing over corresponding weirs 203, 204, through the opening 224, and downwardly over the outer surfaces 205, 206 of the corresponding weirs 203, 204. Respective streams of molten material 121 can then flow along the downwardly inclined converging surface portions 207, 208 of the forming wedge 209 and be drawn off the root 145 of the forming device 101, where the flows converge and fuse into the glass ribbon 103. The glass ribbon 103 can then be drawn along the travel direction 154. In aspects, the glass ribbon 103 comprises one or more states of material based on a vertical location of the glass ribbon 103, i.e., distance from the root 145. For example, at a first location, the glass ribbon 103 can comprise the viscous molten material 121, and at a second location, the glass ribbon 103 can comprise an amorphous solid in a glassy state (e.g., a glass ribbon).

The glass ribbon 103 comprises a first major surface 215 and a second major surface 216 facing opposite directions and defining a thickness 212 (e.g., average thickness) of the glass ribbon 103 therebetween. In aspects, the thickness 212 of the glass ribbon 103 can be less than or equal to about 2 millimeters (mm), less than or equal to about 1 millimeter, less than or equal to about 0.5 millimeters, for example, less than or equal to about 300 microme [symbol] micrometers, or less than or equal to about 100 micrometers, although other thicknesses may be provided in further aspects. For example, in aspects, the thickness 212 of the glass ribbon 103 can be within a range from about 20 micrometers to about 200 micrometers, within a range from about 50 micrometers to about 750 micrometers, within a range from about 100 micrometers to about 700 micrometers, within a range from about 200 micrometers to about 600 micrometers, within a range from about 300 micrometers to about 500 micrometers, within a range from about 50 micrometers to about 500 micrometers, within a range from about 50 micrometers to about 700 micrometers, within a range from about 50 micrometers to about 600 micrometers, within a range from about 50 micrometers to about 500 micrometers, within a range from about 50 micrometers to about 400 micrometers, within a range from about 50 micrometers to about 300 micrometers, within a range from about 50 micrometers to about 200 micrometers, within a range from about 50 micrometers to about 100 micrometers, within a range from about 25 micrometers to about 125 micrometers, comprising all ranges and subranges of thicknesses therebetween. In addition, the glass ribbon 103 can comprise a variety of compositions, for example, one or more of soda-lime glass, borosilicate glass, alumino-borosilicate glass, alkali-containing glass, alkali-free glass, aluminosilicate, borosilicate, boroaluminosilicate, silicate, glass-ceramic, or other materials comprising glass. In aspects, the glass ribbon 103 can comprise one or more of lithium fluoride (LiF), magnesium fluoride (MgF₂), calcium fluoride (CaF₂), barium fluoride (BaF₂), sapphire (Al₂O₃), zinc selenide (ZnSe), germanium (Ge) or other materials.

In aspects, the glass separator 149 (see FIG. 1) can separate the glass ribbon 104 from the glass ribbon 103 along the separation path 151 to provide a plurality of separated glass ribbons 104 (i.e., a plurality of sheets of glass). In aspects, a longer portion of the glass ribbon 104 may be coiled onto a storage roll. The separated glass ribbon can then be processed into a desired application, e.g., a display application. For example, the separated glass ribbon can be used in a wide range of display and non-display applications comprising, but not limited to, liquid crystal displays (LCDs), electrophoretic displays (EPD), organic light emitting diode displays (OLEDs), plasma display panels (PDPs), microLED displays, miniLED displays, organic light emitting diode lighting, light emitting diode light [symbol] (VR), touch sensors, photovoltaics, foldable phones, or other applications.

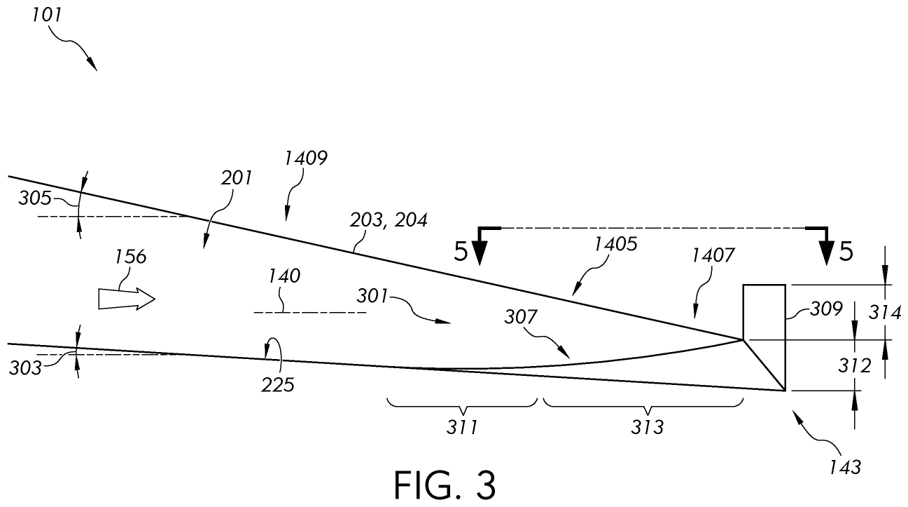

FIG. 3 illustrates a side view of the forming device 101 at focus area 3 of FIG. 1, in which the forming device 101 comprises a diverter 301 positioned within the trough 201. The diverter 301 can divert the molten material 121 over at least one weir of the pair of weirs 203, 204. In aspects, the diverter 301 can be positioned adjacent to the opposing end 143 of the forming device 101 opposite the inlet end 142. In aspects, the diverter 301 can be positioned on and in contact with the bottom surface 225. For example, the diverter 301 can be a separately formed structure that can be attached to the bottom surface 225 (e.g., via gravitational force, fasteners, welding, press-fit, etc.). In this way, the bottom surface 225 may be substantially planar with the diverter 301 resting on the bottom surface 225. In aspects, when the diverter 301 is attached to the forming device 101, the diverter 301 and the forming device 101 may comprise the same material or a different material. For example, when comprising different materials, the forming device 101 may be formed of a ceramic material and the diverter 301 may comprise platinum. The diverter 301 is not limited to being separately attached to the bottom surface 225, but, rather, the diverter 301 and the forming device 101 can be a composite or one-piece formed, for example, with the diverter 301 being machined into (e.g., by milling, grinding, etc.) the bottom surface 225. In this way, the diverter 301 may be homogenous (e.g., one-piece) with the forming device 101, such that the diverter 301 and the forming device 101 comprise the same material.

In aspects, the forming device 101 may be tilted such that the bottom surface 225 and/or the pair of weirs 203, 204 can form angles relative to a horizontal plane that is perpendicular to a gravitational direction. For example, the bottom surface 225 can form a first angle 303 relative to horizontal that is within a range from about +5 degrees to about −5 degrees, or within a range from about 0 degrees to about −3 degrees. In aspects, the pair of weirs 203, 204 (e.g., a top surface) can form a second angle 305 relative to horizontal that is within a range from about −3 degrees to about −8 degrees, or within a range from about −6 degrees to about −7 degrees. By tilting the forming device 101 such that the bottom surface 225 comprises a negative slope, the molten material 121 can flow from the inlet end 142 toward the opposing end 143 under the influence of gravity.

In aspects, the diverter 30 [symbol] deflector portion 309. The body portion 307 is in contact with and resting on the bottom surface 225. The deflector portion 309 can be positioned on the body portion 307, such that the deflector portion 309 is spaced a distance apart from the bottom surface 225. In aspects, the body portion 307 can be positioned partially or completely within the trough 201 and below the pair of weirs 203, 204. The deflector portion 309 may extend upwardly out of the trough 201, such that a top surface of the deflector portion 309 is above the pair of weirs 203, 204 and above a level of the molten material 121. In aspects, the body portion 307 can comprise a first height 312, which may be a maximum height, within a range from about 13 mm to about 51 mm, or within a range from about 19 mm to about 32 mm, or about 25 mm. In aspects, the deflector portion 309 can comprise a second height 314 (e.g., between a top of the body portion 307 and a top of the deflector portion 309) within a range from about 51 mm to about 102 mm, or about 76 mm. The deflector portion 309 may be optional, however, such that, in aspects, the diverter 301 may comprise the body portion 307 without the deflector portion 309. The first height 312 of the body portion 307 can substantially match a height between the bottom surface 225 and the top of the weirs 203, 204 at the end 143. As such, at the end 143, the top of the body portion 307 may be substantially level with the top of the weirs 203, 204. In aspects, the body portion 307 can comprise a first portion 311 and a second portion 313, with the first portion 311 located upstream from the second portion 313 relative to the flow direction 156 of the molten material 121.

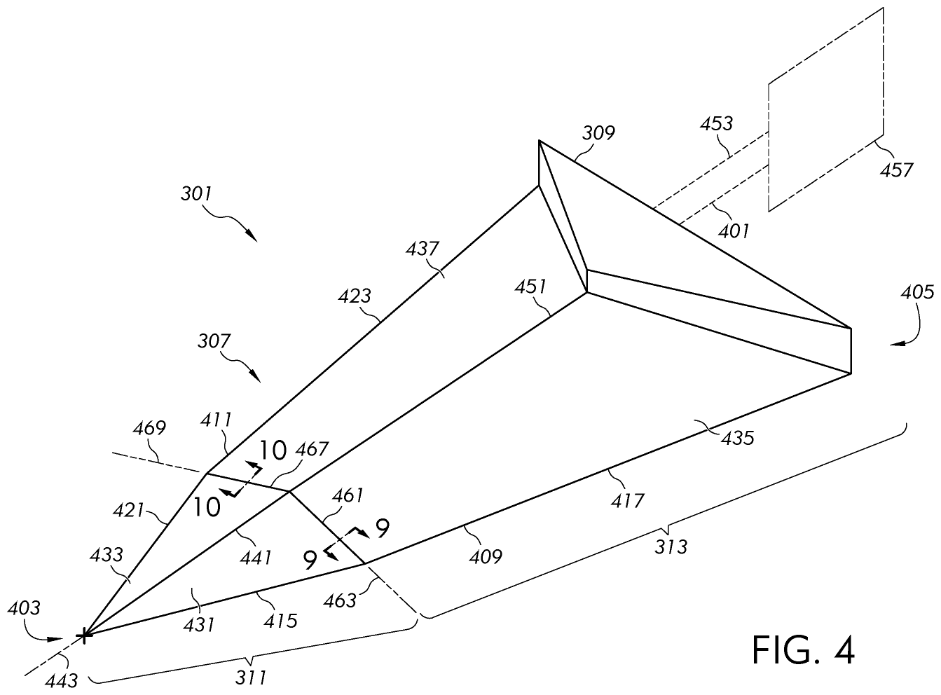

FIG. 4 illustrates a perspective view of the diverter 301. In aspects, the diverter 301 can extend along a diverter axis 401 between a first diverter end 403 and a second diverter end 405. The diverter axis 401 may be substantially parallel to the trough axis 140 (e.g., illustrated in FIGS. 1-3), such that the first diverter end 403 may be in closer proximity to the inlet end 142 than the second diverter end 405 and the second diverter end 405 may be in closer proximity to the opposing end 143 than the first diverter end 403. The diverter 301 can comprise a first edge 409 and a second edge 411 that extend along the diverter axis 401 between the first diverter end 403 and the second diverter end 405. In aspects, the first edge 409 may be non-parallel with the second edge 411, with the first edge 409 and the second edge 411 defining an outermost boundary or perimeter of the diverter 301. The first edge 409 and the second edge 411 can contact the bottom surface 225. In aspects, the first edge 409 can comprise an upstream diverter edge segment 415 and a [symbol] the downstream diverter edge segment 417 nonlinear (e.g., linearly misaligned) with the upstream diverter edge segment 415. By being nonlinear (e.g., linearly misaligned), the upstream diverter edge segment 415 and the downstream diverter edge segment 417 extend along different axes and are non-collinear and non-parallel. In aspects, the upstream diverter edge segment 415 may terminate at the first diverter end 403 and the downstream diverter edge segment 417 may terminate at the second diverter end 405, with the upstream diverter edge segment 415 and the downstream diverter edge segment 417 intersecting and contacting at a location between the first diverter end 403 and the second diverter end 405. In aspects, the downstream diverter edge segment 417 may be positioned downstream from the upstream diverter edge segment 415 relative to the flow direction 156 of the molten material 121. In aspects, the downstream diverter edge segment 417 may be positioned at a higher elevation than the upstream diverter edge segment 415 due to the inclination and tilt of the bottom surface 225 relative to horizontal.

In aspects, the second edge 411 can comprise a second upstream diverter edge segment 421 and a second downstream diverter edge segment 423, with the second downstream diverter edge segment 423 nonlinear (e.g., linearly misaligned) with the second upstream diverter edge segment 421. By being nonlinear (e.g., linearly misaligned), the second upstream diverter edge segment 421 and the second downstream diverter edge segment 423 extend along different axes and are non-collinear and non-parallel. In aspects, the second upstream diverter edge segment 421 may terminate at the first diverter end 403 and the second downstream diverter edge segment 423 may terminate at the second diverter end 405, with the second upstream diverter edge segment 421 and the second downstream diverter edge segment 423 intersecting and contacting at a location between the first diverter end 403 and the second diverter end 405. In aspects, the second downstream diverter edge segment 423 may be positioned downstream from the second upstream diverter edge segment 421 relative to the flow direction 156 of the molten material 121. In aspects, the second downstream diverter edge segment 423 may be positioned at a higher elevation than the second upstream diverter edge segment 421 due to the inclination and tilt of the bottom surface 225 relative to horizontal.

The diverter 301 can comp [symbol] 409 and the second edge 411. For example, the diverter 301 can comprise a first face 431, a second face 433, a third face 435, and a fourth face 437. The first face 431 can comprise the upstream diverter edge segment 415 (e.g., with the upstream diverter edge segment 415 forming an edge of the first face 431), such that the first face 431 can contact the bottom surface 225. In aspects, the first face 431 can lie in a first plane or the first face 431 can be non-planar. The second face 433 can comprise the second upstream diverter edge segment 421 (e.g., with the second upstream diverter edge segment 421 forming an edge of the second face 433), such that the second face 433 can contact the bottom surface 225. The second face 433 can lie in a second plane or the second face 433 can be non-planar. In aspects, the second face 433 is attached to the first face 431, with the first face 431 and the second face 433 attached at a first intersection junction 441 that extends along a first junction axis 443.

The third face 435 can comprise the downstream diverter edge segment 417 (e.g., with the downstream diverter edge segment 417 forming an edge of the third face 435), such that the third face 435 can contact the bottom surface 225. The third face 435 can lie in a third plane or the third face 435 can be non-planar. The fourth face 437 can comprise the second downstream diverter edge segment 423 (e.g., with the second downstream diverter edge segment 423 forming an edge of the fourth face 437), such that the fourth face 437 can contact the bottom surface 225. The fourth face 437 can lie in a fourth plane or the fourth face 437 can be non-planar. In aspects, the third face 435 is attached to the fourth face 437, with the third face 435 and the fourth face 437 attached at a second intersection junction 451 that extends along a second junction axis 453. In aspects, the first intersection junction 441 and the second intersection junction 451 may contact and intersect at a junction of the first face 431, the second face 433, the third face 435, and the fourth face 437. The first junction axis 443 and the second junction axis 453 may be nonlinear (e.g., linearly misaligned), such that the first junction axis 443 and the second junction axis 453 are non-collinear and non-parallel. In aspects, the first junction axis 443 and the second junction axis 453 may lie in a junction plane 457 that extends through the diverter 301 between the first diverter end 403 and the second diverter end 405.

In aspect, the junction plane 457 may bisect the diverter 301, such that the first face 431 and the third face 435 lie on a first side of the diverter 301 (e.g., the junction plane 457), and the second face [symbol] side of the diverter 301 (e.g., the junction plane 457) opposite the first side. In aspects, the diverter 301 is symmetrical about the junction plane 457, for example, with the first face 431 and the third face 435 on the first side of the junction plane 457 symmetrical with the second face 433 and the fourth face 437 on the second side of the junction plane 457. The third face 435 can be attached to the first face 431, with the first face 431 and the third face 435 attached at a third intersection junction 461 that extends along a third junction axis 463. The fourth face 437 can be attached to the second face 433, with the second face 433 and the fourth face 437 attached at a fourth intersection junction 467 that extends along a fourth junction axis 469. In aspects, the third and fourth intersection junctions 461, 467 can intersect at the intersection of the first and second intersection junctions 441, 451. Accordingly, in aspects, the first face 431 and the second face 433 may comprise three sides, for example, with the first face 431 bounded by the upstream diverter edge segment 415, the first intersection junction 441, and the third intersection junction 461. The second face 433 is bounded by the second upstream diverter edge segment 421, the first intersection junction 441, and the fourth intersection junction 467. The third face 435 and the fourth face 437 can comprise fourth sides, for example, with the third face 435 bounded by the downstream diverter edge segment 417, the second intersection junction 451, the third intersection junction 461, and the second diverter end 405. The fourth face 437 can be bounded by the second downstream diverter edge segment 423, the second intersection junction 451, the fourth intersection junction 467, and the second diverter end 405. In aspects, the first portion 311 of the diverter 301 can comprise the first face 431, the second face 433, the upstream diverter edge segment 415, and the second upstream diverter edge segment 421. In aspects, the second portion 313 of the diverter 301 can comprise the third face 435, the fourth face 437, the downstream diverter edge segment 417, and the second downstream diverter edge segment 423.

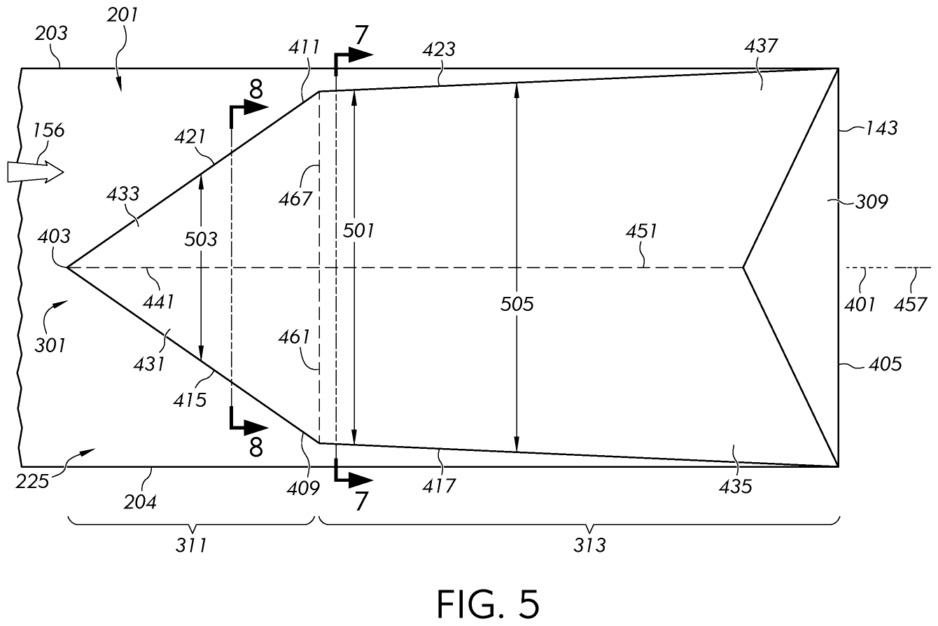

FIG. 5 illustrates a top-down view of the diverter 301 within the trough 201 along lines 5-5 of FIG. 3. In aspects, the first edge 409 and the second edge 411 can intersect at the first diverter end 403 and diverge toward the second diverter end 405. For example, by intersecting at the first diverter end 403, a distance between the first edge 409 and the second edge 411 may be zero at the first diverter end 403. However, a distance 501 separating the first edge 409 and the second edge 411 may increase, for example, at a non-constant ra [symbol] diverter end 403 toward the second diverter end 405. For example, a second distance 503 can separate the upstream diverter edge segment 415 and the second upstream diverter edge segment 421. Due to the upstream diverter edge segment 415 and the second upstream diverter edge segment 421 being non-parallel, the second distance 503 is non-constant and increasing at a constant first rate along the diverter axis 401 from the first diverter end 403 toward the second diverter end 405. A third distance 505 can separate the downstream diverter edge segment 417 and the second downstream diverter edge segment 423. Due to the downstream diverter edge segment 417 and the second downstream diverter edge segment 423 being non-parallel, the third distance 505 is non-constant and increasing at a constant second rate along the diverter axis 401 toward the second diverter end 405. In aspects, the first rate may be different than the second rate, for example, with the first rate being greater than the second rate. In aspects, a maximum width of the diverter 301 (e.g., along a direction perpendicular to the junction plane 457) can be substantially equal to or slightly less than the width of the trough 201 between the weirs 203, 204. In this way, at the second diverter end 405, the first edge 409 and the second edge 411 of the diverter 301 can be adjacent to and/or in contact with the weirs 203, 204.

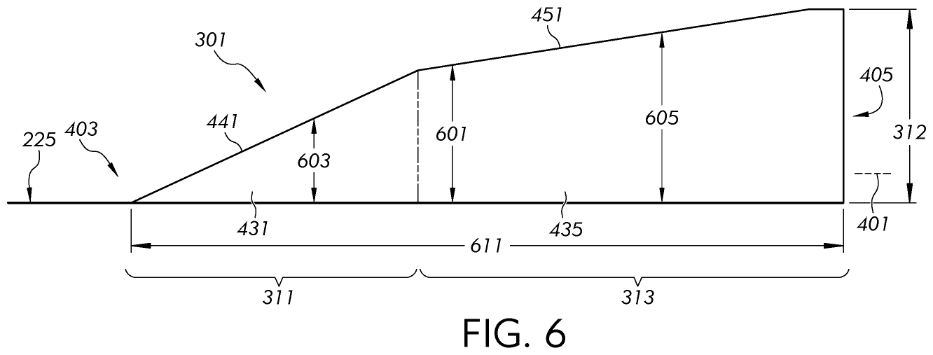

FIG. 6 illustrates a side view of the diverter 301 in contact with the bottom surface 225 within the trough 201. In aspects, the diverter can comprise a height 601 that is increasing from the first diverter end 403 to the second diverter end 405. For example, at the first diverter end 403, the height 601 of the diverter 301 may be zero while at the second diverter end 405, the diverter 301 can comprise a maximum height (e.g., the first height 312). In aspects, the height 601 of the diverter 301 from the bottom surface 225 at a center of the diverter 301 can increase at a non-constant rate along the diverter axis 401 from the first diverter end 403 toward the second diverter end 405. In aspects, the center of the diverter 301 can comprise the intersection junctions 441, 451, such that the center is at a midpoint between the edges 409, 411. The diverter 301 can comprise a first height 603 between the bottom surface 225 and the first intersection junction 441, and a second height 605 between the bottom surface 225 and the second intersection junction 451. In aspects, if the diverter 301 is machined into the forming device 101 (e.g., such that the diverter 301 and the bottom surface 225 are homogenous and are one-piece), then the bottom surface 225 (e.g., at a location upstream from the diverter 301) may exte [symbol] between the plane and the diverter 301. In aspects, the first height 603 can increase at a constant or non-constant first rate from the first diverter end 403 toward the second diverter end 405. In aspects, the second height 605 can increase at a constant or non-constant second rate toward the second diverter end 405. In aspects, the first rate is different than the second rate, for example, in FIG. 6, the first rate is greater than the second rate. The diverter 301 comprises a length 611 between the first diverter end 403 and the second diverter end 405 along the diverter axis 401. In aspects, the length 611 can be within a range from about 305 mm to about 760 mm, or within a range from about 406 mm to about 508 mm.

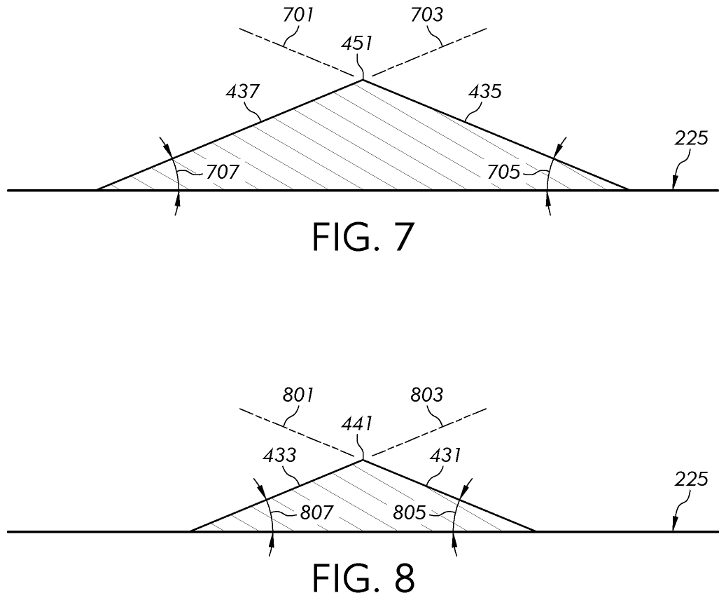

FIGS. 7-8 illustrate cross-sectional views of the diverter 301 at the first intersection junction 441 and the second intersection junction 451. For example, FIG. 7 illustrates a cross-sectional view of the third face 435 and the fourth face 437 along lines 7-7 of FIG. 5. As illustrated in FIG. 7, the third face 435 contacts the bottom surface 225 and lies in a third plane 701 and the fourth face 437 contacts the bottom surface 225 and lies in a fourth plane 703. The third face 435 is attached to the fourth face 437 at the second intersection junction 451, with the third plane 701 non-planar with the fourth plane 703. The third face 435 can form a third angle 705 relative to the bottom surface 225, and the fourth face 437 can form a fourth angle 707 relative to the bottom surface 225. In aspects, the third angle 705 may be substantially equal to the fourth angle 707, for example, when the third face 435 is symmetric with the fourth face 437.

FIG. 8 illustrates a cross-sectional view of the first face 431 and the second face 433 along lines 8-8 of FIG. 5. The first face 431 contacts the bottom surface 225 and lies in a first plane 801 and the second face 433 contacts the bottom surface 225 and lies in a second plane 803. The first face 431 is attached to the second face 433 at the first intersection junction 441, with the first plane 801 non-planar with the second plane 803. The first face 431 can form a first angle 805 relative to the bottom surface 225, and the second face 433 can form a second angle 807 relative to the bottom surface 225. In aspects, the first angle 805 may be substantially equal to the second angle 807, for example, when the first face 431 is symmetric with the second face 433. In aspects, due to the inclination of the first face 431 and the third face 435 (e.g., illustrated in FIG. 7), the first angle 805 may be different than the third angle 705. Similarly, in aspects, due to the inclinatio [symbol] 437 (e.g., illustrated in FIG. 7), the second angle 807 may be different than the fourth angle 707.

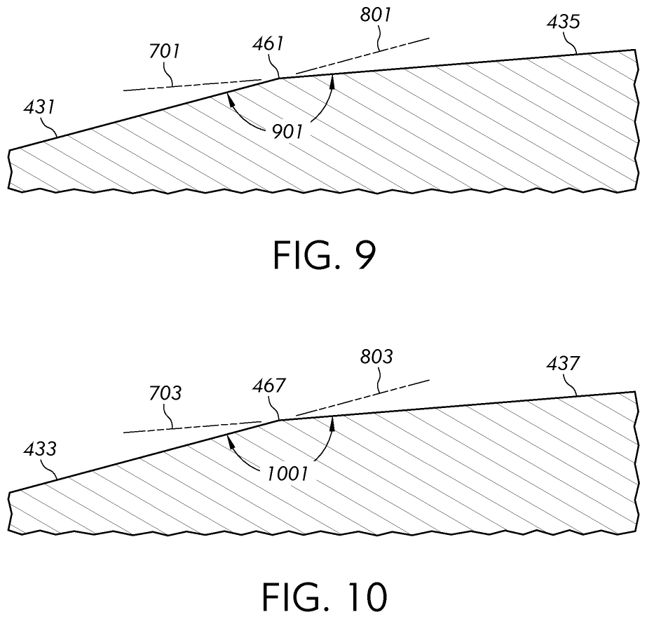

FIGS. 9-10 illustrate cross-sectional views of the diverter 301 at the third intersection junction 461 and the fourth intersection junction 467. For example, FIG. 9 illustrates a cross-sectional view of the first face 431 and the third face 435 along lines 9-9 of FIG. 4. FIG. 10 illustrates a cross-sectional view of the second face 433 and the fourth face 437 along lines 10-10 of FIG. 4. In aspects, the first plane 801 can be non-planar with the third plane 701. For example, the first face 431 can form an angle 901 with the third face 435 that is less than about 180 degrees, for example, with the angle 901 within a range from about 135 degrees to about 170 degrees. In aspects, the second plane 803 can be non-planar with the fourth plane 703. For example, the second face 433 can form an angle 1001 with the fourth face 437 that is less than about 180 degrees, for example, with the angle 1001 within a range from about 135 degrees to about 170 degrees.

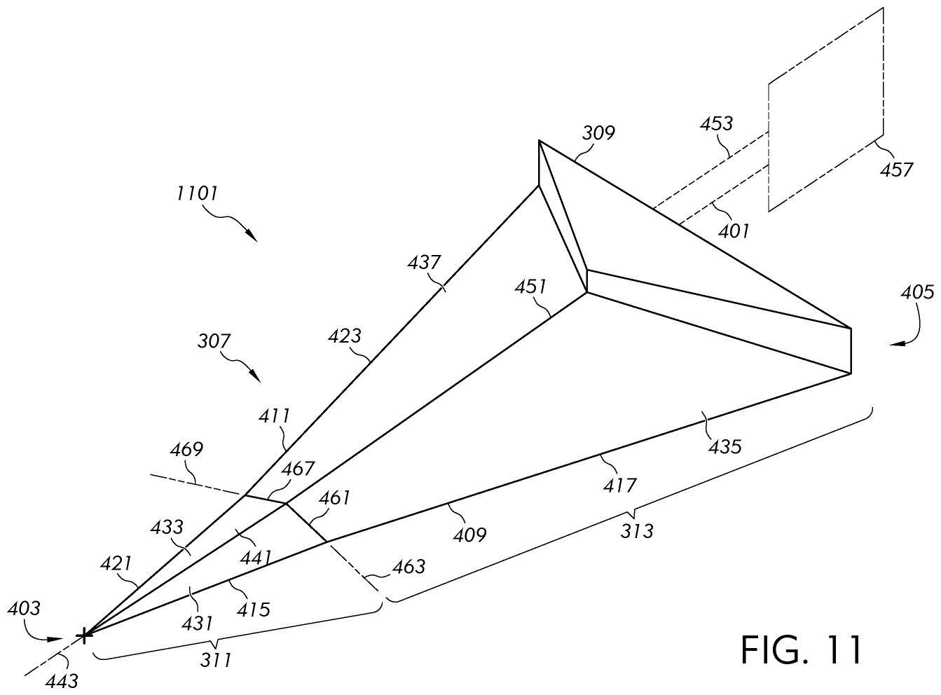

FIG. 11 illustrates additional aspects of a diverter 1101 that is similar to the diverter 301, with common reference numbers between the diverters 301, 1101 referring to common features. For example, the diverter 1101 can comprise the first face 431, the second face 433, the third face 435, the fourth face 437, and can extend between the first diverter end 403 and the second diverter end 405. The diverter 1101 is positioned within the trough 201 in contact with the bottom surface 225 at a substantially identical location as the diverter 301 illustrated in FIG. 3.

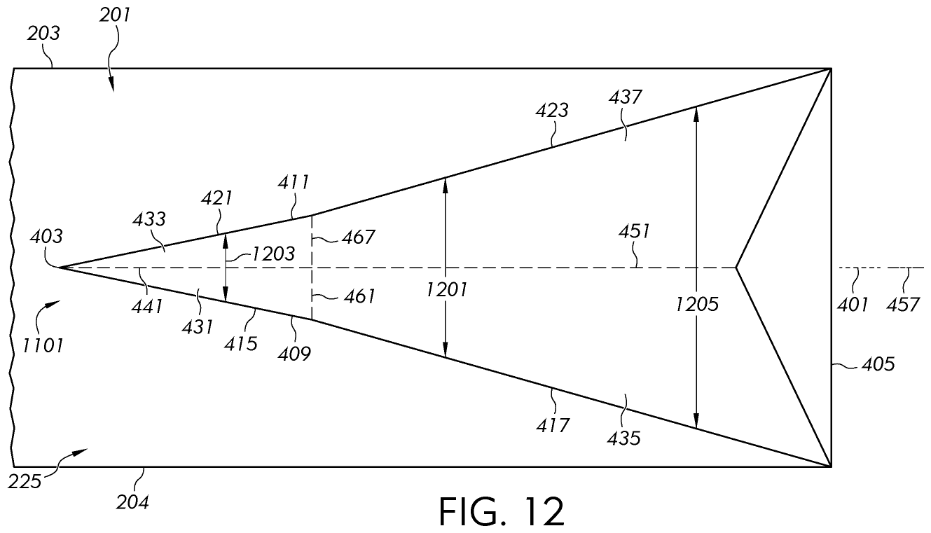

In aspects, the diverter 1101 can comprise differing dimensions than the diverter 301. For example, FIG. 12 illustrates a top-down view of the diverter 1101 within the trough 201. In aspects, the first edge 409 and the second edge 411 can intersect at the first diverter end 403 and diverge toward the second diverter end 405. For example, by intersecting at the first diverter end 403, a distance between the first edge 409 and the second edge 411 may be zero at the first diverter end 403. However, a distance 1201 separating the first edge 409 and the second edge 411 may increase, for example, at a non-constant rate, along the diverter axis 401 from the first diverter end 403 toward the second diverter end 405. For example, a second distance 1203 can separate the upstream diverter edge segment 415 and the second upstream diverter edge segment 421. Due to the upstream diverter edge segment 415 and the second upstream diverter edge segment 421 being non-para [symbol] and increasing at a constant first rate along the diverter axis 401 from the first diverter end 403 toward the second diverter end 405. A third distance 1205 can separate the downstream diverter edge segment 417 and the second downstream diverter edge segment 423. Due to the downstream diverter edge segment 417 and the second downstream diverter edge segment 423 being non-parallel, the third distance 505 is non-constant and increasing at a constant second rate along the diverter axis 401 toward the second diverter end 405. In aspects, the first rate may be different than the second rate, for example, with the first rate being less than the second rate.

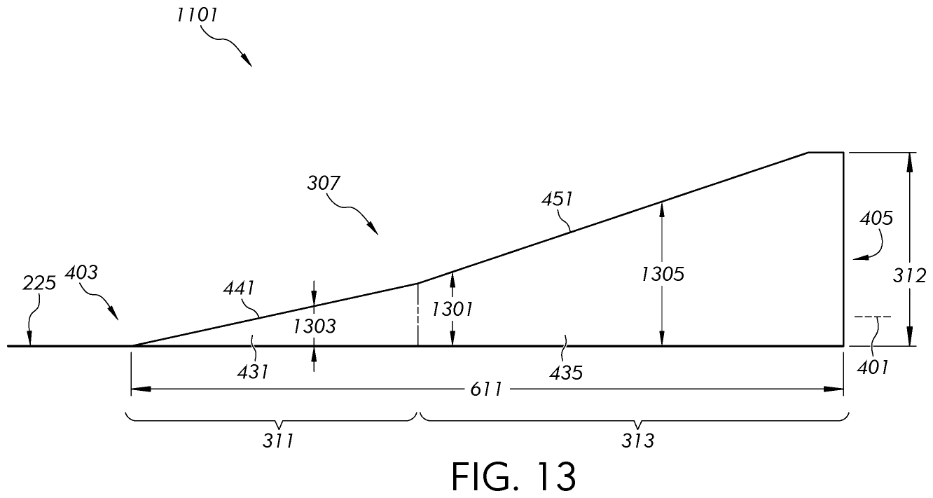

FIG. 13 illustrates a side view of the diverter 1101 in contact with the bottom surface 225 within the trough 201. In aspects, the diverter 1101 can comprise a height 1301 that is increasing from the first diverter end 403 to the second diverter end 405. For example, at the first diverter end 403, the height 1301 of the diverter 301 may be zero while at the second diverter end 405, the diverter 1101 can comprise a maximum height (e.g., the first height 312 at the second diverter end 405). In aspects, the height 1301 of the diverter 1101 from the bottom surface 225 can increase at a non-constant rate along the diverter axis 401 from the first diverter end 403 toward the second diverter end 405. For example, the diverter 1101 can comprise a first height 1303 between the bottom surface 225 and the first intersection junction 441, and a second height 1305 between the bottom surface 225 and the second intersection junction 451. In aspects, the first height 1303 can increase at a constant or non-constant first rate from the first diverter end 403 toward the second diverter end 405. In aspects, the second height 1305 can increase at a constant or non-constant second rate toward the second diverter end 405. In aspects, the first rate is different than the second rate, for example, in FIG. 13, the first rate is less than the second rate.

The diverter 301, 1101 illustrated and described relative to FIGS. 3-13 is not limited to the design and shape disclosed herein. For example, while the faces 431, 433, 435, 437 are illustrated as being substantially planar, in aspects, one or more of the faces 431, 433, 435, 437 may comprise a non-planar shape, for example, by being rounded, concave, convex, etc. Further, while the intersection junctions 441, 451, 461, 467 are illustrated as each being substantially linear, in aspects, one or more of the intersection junctions 441, 451, 461, 467 can comprise a non-linear shape, for example, by being rounded. Further, while the diverter 301, 1101 is illustrated as comprising the first portion 311 and the second portion [symbol] comprise additional portions (e.g., more than two), such that the edges 409, 411 may diverge at more than two rates (e.g., illustrated in FIGS. 5 and 12) and the intersection junctions 441, 451 may increase in height at more than two rates (e.g., illustrated in FIGS. 6 and 13). In aspects, the non-linear or curved shapes can comprise a plurality of lines with different slopes that, together, form the non-linear or curved shape. In addition, while the diverter 301, 1101 is illustrated as being substantially symmetrical, in aspects, the diverter 301, 1101 may be asymmetrical about the junction plane 457.

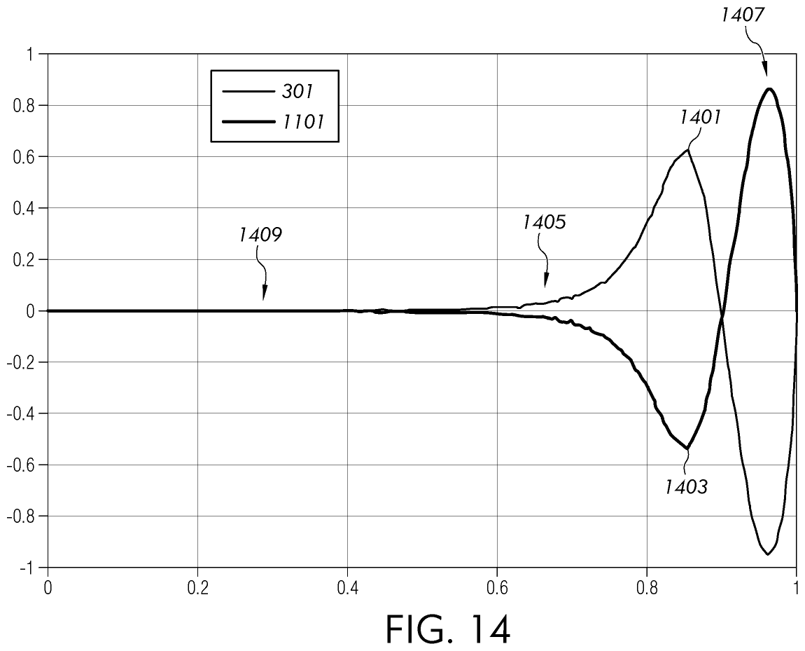

FIG. 14 illustrates a plot of a change in mass of the molten material 121 exiting the trough 201 (e.g., on the y-axis) versus a position within the trough 201 (e.g., on the x-axis). When the change in mass is zero, corresponding to a zero on the y-axis, the flow rate is constant. When the change in mass is positive, then the flow rate is increasing. When the change in mass is negative, then the flow rate is decreasing. The change in mass of the molten material 121 and the position are illustrated with arbitrary units. Line 1401 represents the change in mass from the diverter 301 illustrated in FIGS. 3-10, and line 1403 represents the change in mass from the diverter 1101 illustrated in FIGS. 11-13. On the x-axis, the position ranges from 0 to 1, in which the zero position can represent the inlet end 142, the position at 1 can represent the opposing end 143, and the positions between 0 and 1 can represent positions within the trough 201 between the inlet end 142 and the opposing end 143. A first location 1405, which is at about position 0.6, represents the molten material 121 passing over the first diverter end 403. A second location 1407, which is at about position 0.9, represents the molten material 121 passing over the third and fourth intersection junctions 461, 467. The second diverter end 405 is at the 1 position.

In aspects, depending on the diverter 301, 1101 positioned within the trough 201, differing changes in mass of the molten material 121 exiting the trough 201 can be achieved. For example, at an upstream location 1409 from the diverter 301, 1101 (e.g., between positions 0 to about 0.6), a change in mass of the molten material 121 is about zero, indicating a substantially constant flow rate out of the trough 201. Upon the molten material 121 reaching the diverter 301, 1101, the change in mass can become either positive or negative. For example, with reference to line 1401 representing the diverter 301, the change in mass may increase starting at the first location 1405 (e.g., the first diverter end 403). The change in mass may continue to increase from the first location 1405 to t [symbol] diverter end 403 to the third and fourth intersection junctions 461, 467). From the second location 1407 (e.g., from the third and fourth intersection junctions 461, 467 to the second diverter end 405), the change in mass may decrease. The reason for the change between the first location 1405 and the second location 1407 is due to the geometry of the diverter 301. For example, the second distance 503 may increase more rapidly than the third distance 505 (e.g., as illustrated in FIG. 5) and the first height 603 may increase more rapidly than the second height 605 (e.g., as illustrated in FIG. 6). In this way, the diverter 301 may exhibit a relatively rapid increase in volume from the first diverter end 403. This increase in volume can cause the molten material 121 to flow at a differing rate over the weirs 203, 204 and out of the trough 201.

With reference to line 1403 representing the diverter 1101, the change in mass may decrease starting at the first location 1405 (e.g., the first diverter end 403). The change in mass may continue to decrease from the first location 1405 to the second location 1407 (e.g., from the first diverter end 403 to the third and fourth intersection junctions 461, 467). From the second location 1407 (e.g., from the third and fourth intersection junctions 461, 467 to the second diverter end 405), the change in mass may increase. The reason for the change between the first location 1405 and the second location 1407 is due to the geometry of the diverter 1101. For example, the second distance 1203 may increase more slowly than the third distance 1205 (e.g., as illustrated in FIG. 12) and the first height 1303 may increase more slowly than the second height 1305 (e.g., as illustrated in FIG. 13). In this way, the diverter 1101 may exhibit a relatively slow increase in volume from the first diverter end 403. This increase in volume can cause the molten material 121 to flow at a differing rate over the weirs 203, 204 and out of the trough 201.

Referring to FIGS. 3 and 14, methods can comprise diverting the molten material 121 at an upstream flow rate over the pair of weirs 203, 204 at the upstream location 1409 of the trough 201 upstream from the first location 1405 relative to the flow direction 156. At the upstream location 1409, the molten material 121 can flow over the pair of weirs 203, 204 and may be unaffected by the diverter 301, 1101 due to the upstream location 1409 being upstream from the diverter 301, 1101. In aspects, methods can comprise diverting the molten material 121 at a first flow rate over the pair of weirs 203, 204 at the first location 1405 of the trough 201 when the molten material 121 flows over the first portion 311 of th [symbol] surface 225. The first location 1405 can comprise a location in which a plane, perpendicular to the flow direction 156, intersects the first portion 311 and the pair of weirs 203, 204. As illustrated in FIG. 14, the first flow rate can be different than the upstream flow rate due to the molten material 121 flowing over the first portion 311 of the diverter 301, 1101. In aspects, methods can comprise diverting the molten material 121 at a second flow rate, different than the first flow rate, over the pair of weirs 203, 204 at the second location 1407 of the trough 201 when the molten material 121 flows over the second portion 313 of the diverter 301, 1101, with the second location 1407 positioned downstream from the first location 1405 relative to the flow direction 156. For example, the second location 1407 can comprise a location in which a plane, perpendicular to the flow direction 156, intersects the second portion 313 and the pair of weirs 203, 204. As illustrated in FIG. 14, the second flow rate can be different than the first flow rate due to the molten material 121 flowing over the second portion 313 of the diverter 301, 1101, with the second portion 313 comprising a different shape than the first portion 311. In aspects, and as represented by line 1403 corresponding to the change in mass from the diverter 1101, the first flow rate may be less than the upstream flow rate, and the second flow rate may be greater than the upstream flow rate. In aspects, and as represented by line 1401 corresponding to the change in mass from the diverter 301, the first flow rate may be greater than the upstream flow rate, and the second flow rate may be less than the upstream flow rate.

The diverter 301, 1101 disclosed herein can provide several technical benefits. For example, the shape of the diverter 301, 1101 can yield differing flow rates from an upstream location of the trough 201, such that the flow rates of the molten material 121 exiting the trough 201 can be controlled. In aspects, at the end 143 of the trough 201, all of the molten material 121 has been diverted out of the trough 201 by the diverter 301, 1101, such that a flow rate at the end 143 of the trough 201 is zero. In addition, existing forming devices may not be replaced or dimensionally-adjusted, since the diverter 301, 1101 can be placed on the bottom surface 225 of any forming device to achieve a desired flow rate. In aspects, dimensions (e.g., angles 303, 305, dimension of the trough 201, etc.) of an existing forming device may be obtained, and the diverter 301, 1101 can be constructed based on those dimensions to achieve the desired flow rate. Further, when the diverter 301, 1101 is separately formed from the forming device 101 (e.g., not a one-piece formed compos [symbol] surface 225 may not be machined with the diverter shape, but, rather, can be substantially planar, thus reducing manufacturing costs of the forming device 101 since the substantially planar shape is relatively easier to manufacture.

It should be understood that while various aspects have been described in detail relative to certain illustrative and specific examples thereof, the present disclosure should not be considered limited to such, as numerous modifications and combinations of the disclosed features are possible without departing from the scope of the following claims.

1. A glass manufacturing apparatus comprising:
a forming device comprising a trough extending along a trough axis between an inlet end and an opposing end of the forming device opposite the inlet end, the forming device comprising:
a pair of weirs; and
a diverter positioned within the trough for diverting a molten material over at least one weir of the pair of weirs, the diverter comprising:
a first edge contacting a bottom surface of the trough, the first edge comprising an upstream diverter edge segment and a downstream diverter edge segment nonlinear with the upstream diverter edge segment, the downstream diverter edge segment positioned downstream from the upstream diverter edge segment relative to a flow direction of the molten material in the trough.

2. The glass manufacturing apparatus of claim 1, wherein the bottom surface is substantially planar and extends at least partially between the inlet end and the opposing end.

3. The glass manufacturing apparatus of claim 1, the diverter further comprising a second edge contacting the bottom surface, the second edge comprising a second upstream diverter edge segment and a second downstream diverter edge segment nonlinear with the second upstream diverter edge segment, the second downstream diverter edge segment positioned downstream from the second upstream diverter edge segment.

4. The glass manufacturing apparatus of claim 3, wherein the diverter extends along a diverter axis between a first diverter end and a second diverter end, the first edge and the second edge intersecting at the first diverter end and diverging toward the second diverter end.

5. The glass manufacturing apparatus of claim 4, wherein a distance separating the first edge from the second edge increases at a non-constant rate along the diverter axis from the first diverter end toward the second diverter end.

6. The glass manufacturing apparatus of claim 5, wherein a second distance separating the upstream diverter edge segment and the second upstream diverter edge segment increases at a first rate along the diverter axis toward the second diverter end, and a third distance separating the downstream diverter edge segment and the second downstream diverter edge segment increases at a second rate along the diverter axis toward the second diverter end.

7. The glass manufacturing apparatus of claim 6, wherein the first rate is greater than the second rate.

8. The glass manufacturing apparatus of claim 6, wherein the first rate is less than the second rate.

9. The glass manufacturing apparatus of claim 4, wherein a height of the diverter from the bottom surface at a center of the diverter increases at a non-constant rate along the diverter axis from the first diverter end toward the second diverter end.

10. The glass manufacturing apparatus of claim 1, wherein the diverter is homogeneous with the forming device.

11. The glass manufacturing apparatus of claim 1, wherein the forming device is formed of a ceramic material and the diverter comprises platinum.

12. A glass manufacturing apparatus comprising:
a forming device comprising a trough extending along a trough axis between an inlet end and an opposing end of the forming device opposite the inlet end, the forming device comprising:
a bottom surface at least partially defining the trough and a pair of weirs extending from the bottom surface; and
a diverter positioned within the trough configured to divert a molten material over at least one weir of the pair of weirs, the diverter extending along a diverter axis between a first diverter end and a second diverter end, a height of the diverter from the bottom surface at a center of the diverter increasing at a non-constant rate along the diverter axis from the first diverter end toward the second diverter end.

13. The glass manufacturing apparatus of claim 12, the diverter further comprising:
a first face contacting the bottom surface and lying in a first plane;
a second face contacting the bottom surface and lying in a second plane, the second face attached to the first face;
a third face contacting the bottom surface and lying in a third plane non-planar with the first plane, the third face attached to the first face; and
a fourth face contacting the bottom surface and lying in a fourth plane non-planar with the second plane, the fourth face attached to the second face and the third face.

14. The glass manufacturing apparatus of claim 13, wherein the first face and the third face lie on a first side of the diverter, and the second face and the fourth face lie on a second side of the diverter opposing the first side.

15. The glass manufacturing apparatus of claim 14, wherein the first face forms a first angle relative to the bottom surface, and the third face forms a third angle relative to the bottom surface, the first angle different than the third angle.

16. The glass manufacturing apparatus of claim 14, wherein the second face forms a second angle relative to the bottom surface, and the fourth face forms a fourth angle relative to the bottom surface, the second angle different than the fourth angle.

17. A method of manufacturing glass comprising:
directing a molten material along a flow direction within a trough of a forming device, the trough comprising a bottom surface and a pair of weirs extending from the bottom surface;
flowing the molten material over the pair of weirs;
diverting the molten material at a first flow rate over the pair of weirs at a first location of the trough when the molten material flows over a first portion of a diverter attached to the bottom surface; and
diverting the molten material at a second flow rate, different than the first flow rate, over the pair of weirs at a second location of the trough when the molten material flows over a second portion of the diverter, the second location positioned downstream from the first location relative to the flow direction.

18. The method of claim 17, further comprising diverting the molten material at an upstream flow rate over the pair of weirs at a location of the trough upstream from the first location relative to the flow direction.

19. The method of claim 18, wherein the first flow rate is less than the upstream flow rate and the second flow rate is greater than the upstream flow rate.

20. The method of claim 18, wherein the first flow rate is greater than the upstream flow rate and the second flow rate is less than the upstream flow rate.
